(19) United States
(12) Patent Application Publication
(10) Pub. No.: US 2008/0254267 A1
(43) Pub. Date: Oct. 16, 2008

(54) PRINTED MATTER AND FABRICATION METHOD THEREOF

(76) Inventor: Chien-Chao Chen, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 12/100,425

(22) Filed: Apr. 10, 2008

(30) Foreign Application Priority Data
Apr. 12, 2007 (TW) 96112827
Nov. 27, 2007 (TW) 96144980

(51) Int. Cl. B32B 3/10; B05D 5/00

(52) U.S. Cl. 428/207; 427/256

(57) ABSTRACT

A printed matter including a base and a printed pattern layer disposed on the base is provided. The printed pattern layer includes printing ink and photocatalytic powders. The printing ink is disposed on the base. The photocatalytic powders are dispersed in the printing ink. A fabrication method of a printed matter including following steps is also provided. First, a base is provided. Next, a printed pattern layer is printed on the base. The printed pattern layer has printing ink disposed on the base and photocatalytic powders dispersed in the printing ink.

### CROSS-REFERENCE TO RELATED APPLICATION

This application claims the priority benefits of Taiwan applications serial no. 96112827, filed on Apr. 12, 2007 and serial no. 96144980, filed on Nov. 27, 2007. The entirety of each of the above-mentioned patent applications is hereby incorporated by reference herein and made a part of this specification.

### BACKGROUND OF THE INVENTION

1. Field of the Invention

The present invention relates to a printed matter and a fabrication method thereof, and more particularly to a printed matter with photocatalytic powders and a fabrication method thereof.

2. Description of Related Art

Despite that people's living conditions are improved due to global industrialization, environmental pollution is also introduced. In order to solve the increasingly serious environmental pollution, many countries have spent considerable money in researching relevant technologies. The photocatalytic technology is found in such a background and it is still further developing.

Photocatalysts could efficiently eliminate contaminants in liquid or gas. Since the photocatalysts merely serve as catalysts in a chemical reaction with light irradiation, photocatalysts themselves do not be consumed and no side effect is caused. Therefore, using the photocatalysts becomes one of environment-protection approaches for preventing air or water's pollutions.

The photocatalysts are catalysts used in a catalytic reaction causing by light energy. The photocatalytic reaction principle is letting electrons in the photocatalysts to escape after obtaining sufficient energy through the irradiation of UV light or visible light. Holes with positive electricity are formed in the positions where the electrons escape. The holes will oxidize the hydroxyls (OH—) dissociated from water molecules, i.e., the holes capture the electrons of the hydroxyls, to generate active hydroxyl radicals (OH). The escaping electrons reduce the oxygen to generate active superoxide anion radicals (O₂—). The hydroxyl radicals (OH) and superoxide radicals (O₂—) may decompose organic substances (such as contaminants or bacteria) to generate water and CO₂. Therefore, the photocatalysts may eliminate filth and bacteria.

The material serving as the photocatalysts includes oxides such as TiO₂, ZnO, SnO₂ or ZrO₂, or sulphides such as CdS or ZnS. Since TiO₂ has some merits such as strong oxidation and reduction capability, stable chemical properties, no toxicity, and a low price, TiO₂ has been used in the photocatalytic household appliances and respirators up to now from 1972 when TiO₂ was discovered.

In view of the above, the photocatalysts are mostly valuable in eliminating harmful substances by using nature light sources without causing secondary pollution. Therefore, how to efficiently apply the photocatalytic technology in routine products has become a topic which is worthy to be researched and developed.

### SUMMARY OF THE INVENTION

The present invention is directed to providing a printed matter, which has photocatalytic powders such that a surface of the printed matter is not easily contaminated by filth or bacteria.

The present invention is further directed to providing a fabrication method of a printed matter, wherein the printed matter with the photocatalytic powders is fabricated by using existing fabrication equipments.

The present invention provides a printed matter, which includes a base and a printed pattern layer disposed on the base. The printed pattern layer includes printing ink and first photocatalytic powders. The printing ink is disposed on the base, and the photocatalytic powders are dispersed in the printing ink.

In an embodiment of the present invention, the first photocatalytic powders are photocatalytic nanopowders.

In an embodiment of the present invention, the material of the first photocatalytic powders includes TiO₂, SnO₂, ZrO₂, ZnO, Nb₂O₅, WO₃, ZnS, CdS or combinations thereof.

In an embodiment of the present invention, the material of the base includes paper, plastics, or metals.

In an embodiment of the present invention, the printed matter further includes a transparent and permeable protective layer disposed on the base and covering the printed pattern layer. The transparent and permeable protective layer comprises second photocatalytic powders. The second photocatalytic powders are photocatalytic nanopowders. The material of the second photocatalytic powders comprises TiO₂, SnO₂, ZrO₂, ZnO, Nb₂O₅, WO₃, ZnS, CdS or combinations thereof.

The present invention provides a fabrication method of a printed matter, which includes following steps. First, a base is provided. Then, a printed pattern layer is printed on the base. The printed pattern layer includes printing ink disposed on the base and first photocatalytic powders dispersed in the printing ink.

In an embodiment of the present invention, the first photocatalytic powders are photocatalytic nanopowders.

In an embodiment of the present invention, the material of the first photocatalytic powders includes TiO₂, SnO₂, ZrO₂ , ZnO , Nb₂O₅ , WO₃ , ZnS, CdS or combinations thereof.

In an embodiment of the present invention, the material of the base includes paper, plastics, and metals.

In an embodiment of the present invention, the fabrication method of a printed matter further includes forming a transparent and permeable protective layer on the base to cover the printed pattern layer. The transparent and permeable protective layer comprises second photocatalytic powders. The second photocatalytic powders are photocatalytic nanopowders. The material of the second photocatalytic powders comprises TiO₂, SnO₂, ZrO₂, ZnO, Nb₂O₅, WO₃, ZnS, CdS or combinations thereof.

Since the printed pattern layer of the printed matter provided by the present invention has the aforementioned photocatalytic powders, the photocatalytic powders irradiated by ambient light may decompose organic substances (such as contaminants or bacteria) near a surface of the base to eliminate filth and bacteria on the surface of the base. Furthermore, since the printed pattern layer of the printed matter of the present invention is formed by means of printing, the fabrication method of a printed matter provided by the present invention may be carried out by using existing fabrication equipments without spending more for purchasing fabrication equipments.

In order to the make aforementioned and other objects, features and advantages of the present invention comprehensible, a preferred embodiment accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic side view of a printed matter according to an embodiment of the present invention.

FIGS. 2A-2C are schematic views of the fabrication method of the printed matter in FIG. 1.

### DESCRIPTION OF EMBODIMENTS

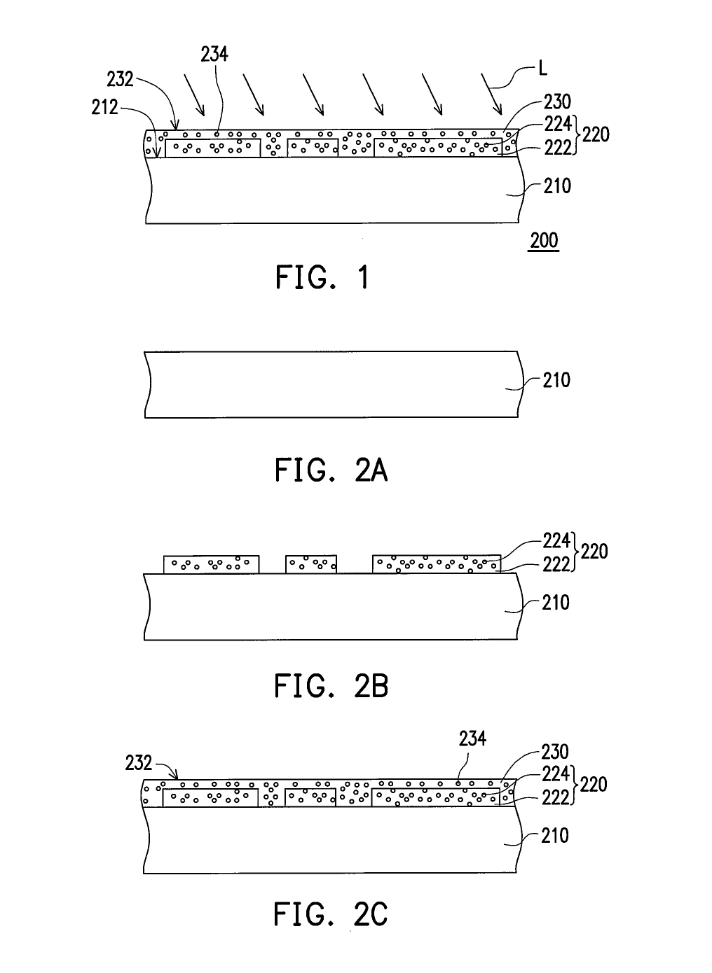

FIG. 1 is a schematic side view of a printed matter according to an embodiment of the present invention. Referring to FIG. 1, in this embodiment, a printed matter 200 includes a base 210 and a printed pattern layer 220 disposed on the base 210. The printed pattern layer 220 includes printing ink 222 and photocatalytic powders 224. The printing ink 222 is disposed on the base 210 and the photocatalytic powders 224 are dispersed in the printing ink 222.

In this embodiment, the photocatalytic powders 224 are photocatalytic nanopowders, and the particle size of each photocatalytic nanopowder has been nanosized. Specifically, the particle size of each photocatalytic nanopowder may be larger than 0 nanometers and smaller than or equal to 100 nanometers. If the photocatalytic powders 224 are photocatalytic nanopowders, the ratio of the surface area to the volume of each photocatalytic powder 224 is increased to enhance the reaction efficiency of the photocatalytic powders 224.

In this embodiment, the material of each of the photocatalytic powders 224 includes TiO₂, SnO₂, ZrO₂, ZnO, Nb₂O₅, WO₃, ZnS, CdS, or other materials serving as the photocatalysts. The pattern of the printed pattern layer 220 includes symbols, characters, or pictures, and the printing ink 222 includes color ink, black ink or white ink.

In this embodiment, the material of the base 210 includes paper, plastics, or metals. When the material of the base 210 includes paper, the printed matter 200 may be used as inside pages of reading matters, covers of reading matters, paper packaging boxes, or aluminum foil packaging boxes. When the material of the base 210 includes plastics, the printed matter 200 may be used as plastic bags or plastic signboards. When the material of the base 210 includes metals, the printed matter 200 may be used as easy open cans or metal signboards.

In this embodiment, the printed matter 200 further includes a transparent and permeable protective layer 230 disposed on the base 210 and the transparent and permeable protective layer 230 covers the printed pattern layer 220. The transparent and permeable protective layer 230 is used to protect the printed pattern layer 220 and prevent the printed pattern layer 220 from coming off the base 210. Furthermore, when the printed pattern layer 220 is irradiated by ambient light L, water moisture in the air may react with the photocatalytic powders 224 in the printed pattern layer 220 to generate free radicals which pass through the transparent and permeable protective layer 230 to eliminate filth and bacteria on a surface 232 of the transparent and permeable protective layer 230. In addition, according to the design requirement, the transparent and permeable protective layer 230 of the present embodiment comprises photocatalytic powders 234 of which quality and function are similar to those of the photocatalytic powders 224 and are not repeated herein.

In another embodiment, according to the design requirement, the designer may omit the disposition of the transparent and permeable protective layer 230, but that is not illustrated in any drawing. In the another embodiment, as irradiated by ambient light L, the photocatalytic powders 224 of the printing ink 222 decompose organic substances (such as contaminants or bacteria) near a surface 212 of the base 210 to eliminate filth and bacteria on the surface 212 of the base 210.

A fabrication method of the printed matter 200 is illustrated as follows. FIGS. 2A-2C are schematic views of the fabrication method of the printed matter in FIG. 1. In this embodiment, the fabrication method of the printed matter includes following steps. First, referring to FIG. 2A, a base 210 is provided. The material of the base 210 includes paper, plastics, or metals.

Subsequently, referring to FIG. 2B, a printed pattern layer 220 is printed on the base 210. The printed pattern layer 220 has printing ink 222 disposed on the base 210 and photocatalytic powders 224 dispersed in the printing ink 222. It should be mentioned here that, the photocatalytic powders 224 may be added to the printing ink 222 in advance before the printed pattern layer 220 is printed, such that the photocatalytic powders 224 are dispersed in the printing ink 222. Furthermore, the method of printing the printed pattern layer 220 includes offset printing, relief printing, intaglio printing, porous printing or ink jet printing.

Then, referring to FIG. 2C, a transparent and permeable protective layer 230 is formed on the base 210 to cover the printed pattern layer 220, so as to protect the printed pattern layer 220 and prevent the printed pattern layer 220 from coming off the base 210. Furthermore, when the printed pattern layer 220 is irradiated by ambient light L (see FIG. 1), water moisture in the air may react with the photocatalytic powders 224 in the printed pattern layer 220 to generate free radicals which pass through the transparent and permeable protective layer 230 to eliminate filth and bacteria on the surface 232 of the transparent and permeable protective layer 230. In addition, according to the design requirement, the transparent and permeable protective layer 230 of the present embodiment comprises photocatalytic powders 234 of which quality and function are similar to those of the photocatalytic powders 224 and are not repeated herein.

It should be mentioned here that, a subsequent fabrication step may be performed on the printed matter 200 upon design requirements, for example, the printed matter 200 may be bound up with other printed matters (not shown) into one volume, or may be formed into a packaging box or a packaging bag.

In view of the above, the printed matter and the fabrication method thereof provided by the present invention at least have the following advantages.

1. Since the printed pattern layer of the printed matter provided by the present invention has the photocatalytic powders, when the photocatalytic powders are irradiated by ambient light, the photocatalytic powders may react with water moisture in the air to generate free radicals to decompose the organic substances (such as contaminants or bacteria) near the surface of the base to eliminate filth and bacteria on the surface of the base.

2. Since the printed pattern layer of the printed matter of the present invention is formed by means of printing, the fabrication method of a printed matter provided by the present invention may be carried out by using existing fabrication equipments without spending more for purchasing fabrication equipments.

3. Since the transparent and permeable protective layer is disposed on the base and covers the printed pattern layer, the transparent and permeable protective layer can protect the printed pattern layer and prevent the printed pattern layer from coming off the base. In addition, when the printed pattern layer is irradiated by ambient light, water moisture in the air may react with the photocatalytic powders in the printed pattern layer to generate free radicals which pass through the transparent and permeable protective layer to eliminate filth and bacteria on the surface of the transparent and permeable protective layer.

4. Since the transparent and permeable protective layer is disposed on the base and covers the printed pattern layer and the transparent and permeable protective layer comprises photocatalytic powders, water moisture in the air may react with the photocatalytic powders in the transparent and permeable protective layer to generate free radicals to eliminate filth and bacteria on the surface of the transparent and permeable protective layer when the transparent and permeable protective layer is irradiated by ambient light.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A printed matter, comprising:
a base; and
a printed pattern layer, disposed on the base, wherein the printed pattern layer comprises:
printing ink, disposed on the base; and
first photocatalytic powders, dispersed in the printing ink.

2. The printed matter as claimed in claim 1, wherein the first photocatalytic powders are photocatalytic nanopowders.

3. The printed matter as claimed in claim 1, wherein the material of the first photocatalytic powders comprises TiO₂, SnO₂, ZrO₂, ZnO, Nb₂O₅, WO₃, ZnS, CdS or combinations thereof.

4. The printed matter as claimed in claim 1, wherein the material of the base comprises paper, plastics, or metals.

5. The printed matter as claimed in claim 1, further comprising a transparent and permeable protective layer disposed on the base and covering the printed pattern layer.

6. The printed matter as claimed in claim 5, wherein the transparent and permeable protective layer comprises second photocatalytic powders.

7. The printed matter as claimed in claim 6, wherein the second photocatalytic powders are photocatalytic nanopowders.

8. The printed matter as claimed in claim 6, wherein the material of the second photocatalytic powders comprises TiO₂, SnO₂, ZrO₂, ZnO, Nb₂O₅, WO₃, ZnS, CdS or combinations thereof.

9. A fabrication method of a printed matter, comprising:
providing a base; and
printing a printed pattern layer on the base, wherein the printed pattern layer comprises printing ink disposed on the base and first photocatalytic powders dispersed in the printing ink.

10. The fabrication method of a printed matter as claimed in claim 9, wherein the first photocatalytic powders are photocatalytic nanopowders.

11. The fabrication method of a printed matter as claimed in claim 9, wherein the material of the first photocatalytic powders comprises TiO₂, SnO₂, ZrO₂, ZnO, Nb₂O₅, WO₃, ZnS, CdS or combinations thereof.

12. The fabrication method of a printed matter as claimed in claim 9, wherein the material of the base comprises paper, plastics, or metals.

13. The fabrication method of a printed matter as claimed in claim 9, further comprising:
forming a transparent and permeable protective layer on the base to cover the printed pattern layer.

14. The fabrication method of a printed matter as claimed in claim 13, wherein the transparent and permeable protective layer comprises second photocatalytic powders.

15. The fabrication method of a printed matter as claimed in claim 14, wherein the second photocatalytic powders are photocatalytic nanopowders.

16. The fabrication method of a printed matter as claimed in claim 14, wherein the material of the second photocatalytic powders comprises TiO₂, SnO₂, ZrO₂, ZnO, Nb₂O₅, WO₃, ZnS, CdS or combinations thereof.
